(19) United States
(12) Patent Application Publication
(10) Pub. No.: US 2016/0018050 A1
(43) Pub. Date: Jan. 21, 2016

(54) Portable Electronic Device Holders with Stand System and Methods to Manufacture Portable Electronic Device Holders with Stand System

(71) Applicant: Karsten Manufacturing Corporation, Phoenix, AZ (US)

(72) Inventors: John A. Solheim, Phoenix, AZ (US); Olly Eades, Loughborough (GB); Calvin Wang, Phoenix, AZ (US); Les Bryant, Phoenix, AZ (US); Martin Jertson, Phoenix, AZ (US)

(21) Appl. No.: 14/738,731

(22) Filed: Jun. 12, 2015

Related U.S. Application Data
(63) Continuation-in-part of application No. 14/015,172, filed on Aug. 30, 2013, now Pat. No. 9,108,096.

(51) Int. Cl. F16M 11/04; G06F 1/16; F16M 11/14; A63B 69/36; F16B 2/12; F16M 11/16

(52) U.S. Cl. CPC F16M 11/04; F16B 2/12; F16M 11/16; F16M 11/14; A63B 69/36; G06F 1/166

(57) ABSTRACT

Embodiments of portable electronic device holders and methods of manufacture of portable electronic device holders are generally described herein. Other embodiments may be described and claimed.

### CROSS REFERENCES

This is a continuation in part of U.S. Non-Provisional Patent Application No. 14/015,172, filed on Aug. 30, 2013.

### FIELD

The present disclosure relates generally to sport accessories, and more particularly, to a portable electronic device holders and methods to manufacture portable electronic device holders.

### BACKGROUND

In golf, some training devices may be an integral part of a golf club (i.e., built-in). That is, the golf club may not be readily used for play in a round of golf. Alternatively, other training devices may only function as a golf training device such that the training device may not be used for other purposes. Instead of the types of training device for golf mentioned above, individuals may use already-owned and/or everyday-used portable electronic devices as a training device for golf.

### BRIEF DESCRIPTION OF THE DRAWINGS

FIG. 1 shows a perspective view of a portable electronic device holder according to one embodiment.

FIG. 2 shows a rear perspective view of the portable electronic device holder of FIG. 1.

FIG. 3 shows a rear perspective view of the portable electronic device holder of FIG. 1 shown attached to a golf club shaft.

FIG. 4 shows a top view of the portable electronic device holder of FIG. 1.

FIG. 5 shows a bottom view of the portable electronic device holder of FIG. 1.

FIG. 6 shows a side view of the portable electronic device holder of FIG. 1.

FIG. 7 shows another side view of the portable electronic device holder of FIG. 1 shown attached to a golf club shaft.

FIGS. 8 and 9 show side views of a section of the portable electronic device holder of FIG. 1.

FIG. 10 shows a front view of the portable electronic device holder of FIG. 1 with an exemplary portable electronic device mounted on the portable electronic device holder.

FIG. 11 shows a method of manufacturing a portable electronic device holder according to one embodiment.

FIG. 12 shows a perspective view of a portable electronic device holder according to another embodiment.

FIG. 13 shows a rear perspective view of the portable electronic device holder of FIG. 12.

FIG. 14 shows a bottom view of the portable electronic device holder of FIG. 12.

FIG. 15 shows a top view of the portable electronic device holder of FIG. 12.

FIG. 16 shows a side view of the portable electronic device holder of FIG. 12.

FIG. 17 shows another side view of the portable electronic device holder of FIG. 12 shown attached to a golf club shaft.

FIGS. 18 and 19 show side views of a section of the portable electronic device holder of FIG. 12.

FIG. 20 shows a front view of the portable electronic device holder of FIG. 12 with an exemplary portable electronic device mounted on the portable electronic device holder.

FIG. 21 shows a perspective view of a stand system for an exemplary portable electronic device holder.

FIG. 22 shows an enlarged perspective view of the stand system of FIG. 21.

FIG. 23 shows a perspective view of a coupling member of the stand system of FIG. 21.

FIG. 24 shows another perspective view of the coupling member of FIG. 23.

FIG. 25 shows a bottom view of the coupling member of FIG. 24.

### DESCRIPTION

In general, apparatus, methods, and articles of manufacture associated with a portable electronic device holder are described herein. The methods, apparatus, and articles of manufacture described herein are not limited in this regard.

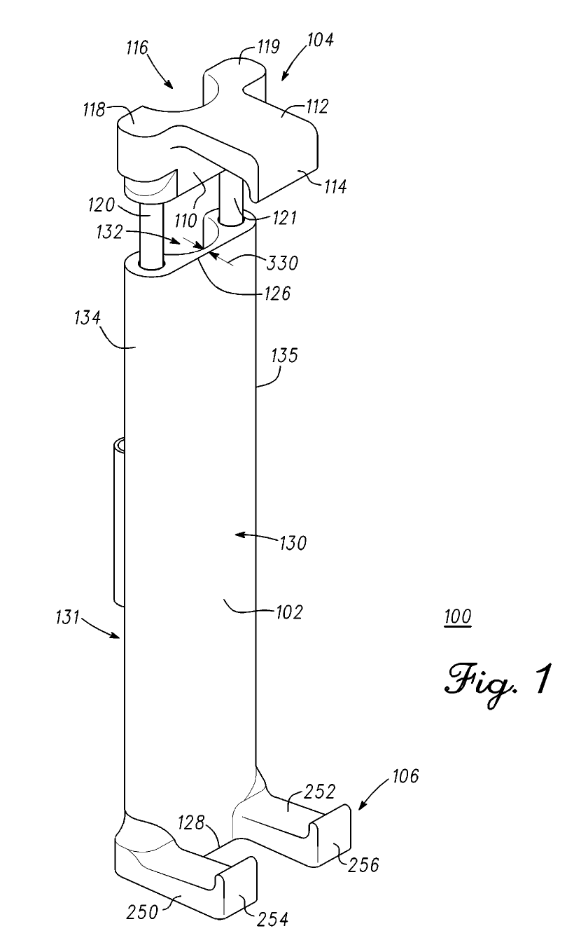

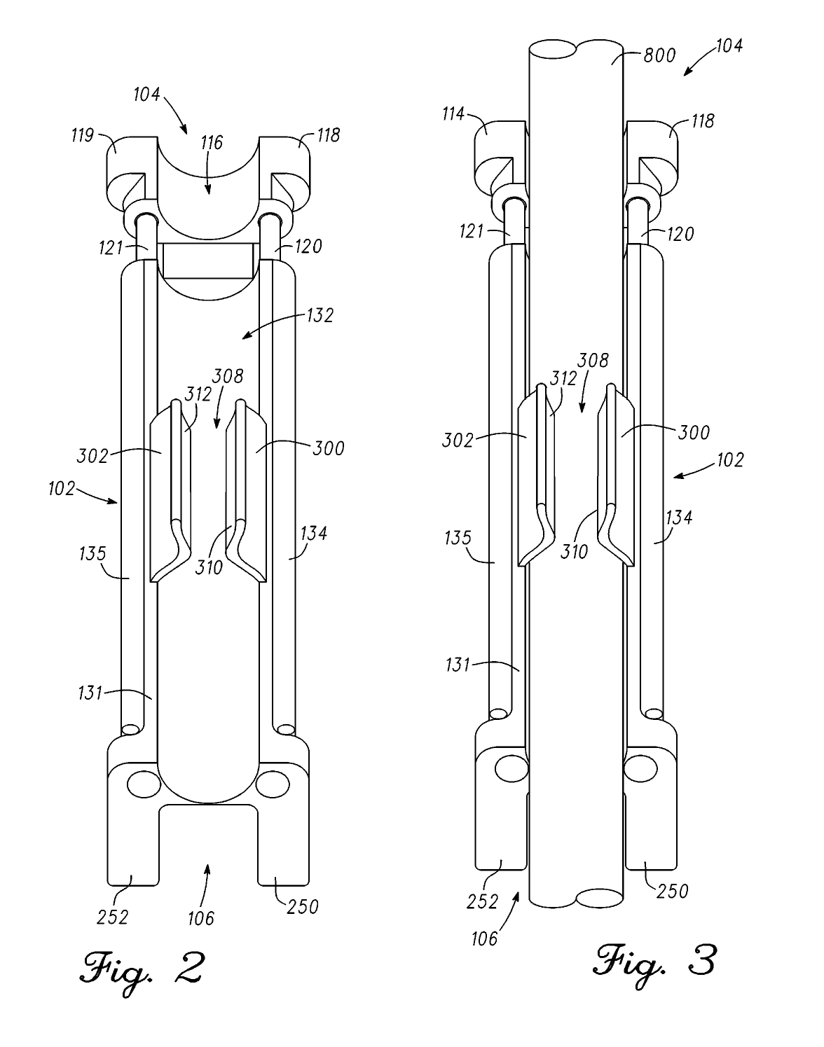

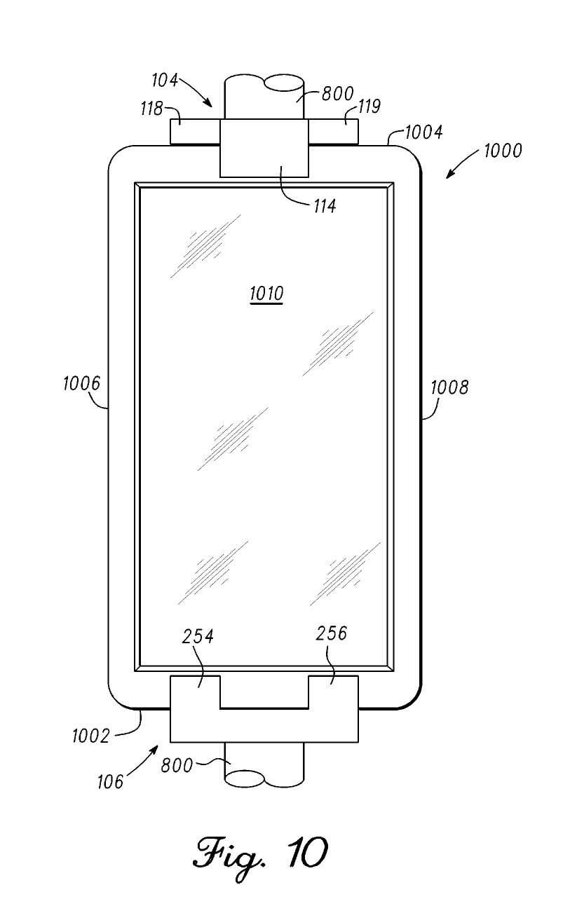

In the example of FIGS. 1-10, a portable electronic device holder 100 may include a body portion 102, a first clamp portion 104 and a second clamp portion 106. As described in detail below, the portable electronic device holder 100 may be configured to removably attach a portable electronic device 1000 (generally shown in FIGS. 7 and 10) such as a wireless communication device and/or a portable media player to a golf club shaft 800 (generally shown in FIGS. 3-5, 7 and 10) of a golf club (e.g., a putter-type golf club). For example, the portable electronic device 1000 may be a media player (e.g., an IPOD® mobile digital device from Apple Inc., Cupertino, Calif.), a wireless telephone (e.g., an IPHONE® mobile digital device from Apple Inc., Cupertino, Calif.), a handheld or tablet computer (e.g., an IPAD® from Apple Inc., Cupertino, Calif.), a global positioning system (GPS) device, a game console device, a digital camera, a video camera, and/or any other electronic device that may be include any type of sensor (e.g., accelerometer, gyroscope, microphone, CCD imaging sensor, CMOS imaging sensor, etc.) for sensing and collecting data and/or images. The portable electronic device 1000 may be configured to operate as a training device (e.g., the portable electronic device 1000 may include a processor to execute a software application), such as a golf training device. In addition or alternatively, the portable electronic device 1000 may be configured to operate as a telephone or a speaker broadcasting music. As shown by the example of FIGS. 7 and 10, a portable electronic device 1000 may include a bottom portion 1002, a top portion 1004, a first side portion 1006, a second side portion 1008 that is opposite to the first side portion 1006, a display portion 1010 and a back portion 1012 (shown in FIG. 7). However, a portable electronic device may be in any shape such as oval, circular, triangular, spherical or other geometric and non-geometric shapes. Accordingly, a first clamp portion 104 and a second clamp portion 106 may be configured to provide engagement with any portable electronic device. The apparatus and articles of manufacture described herein are not limited in this regard.

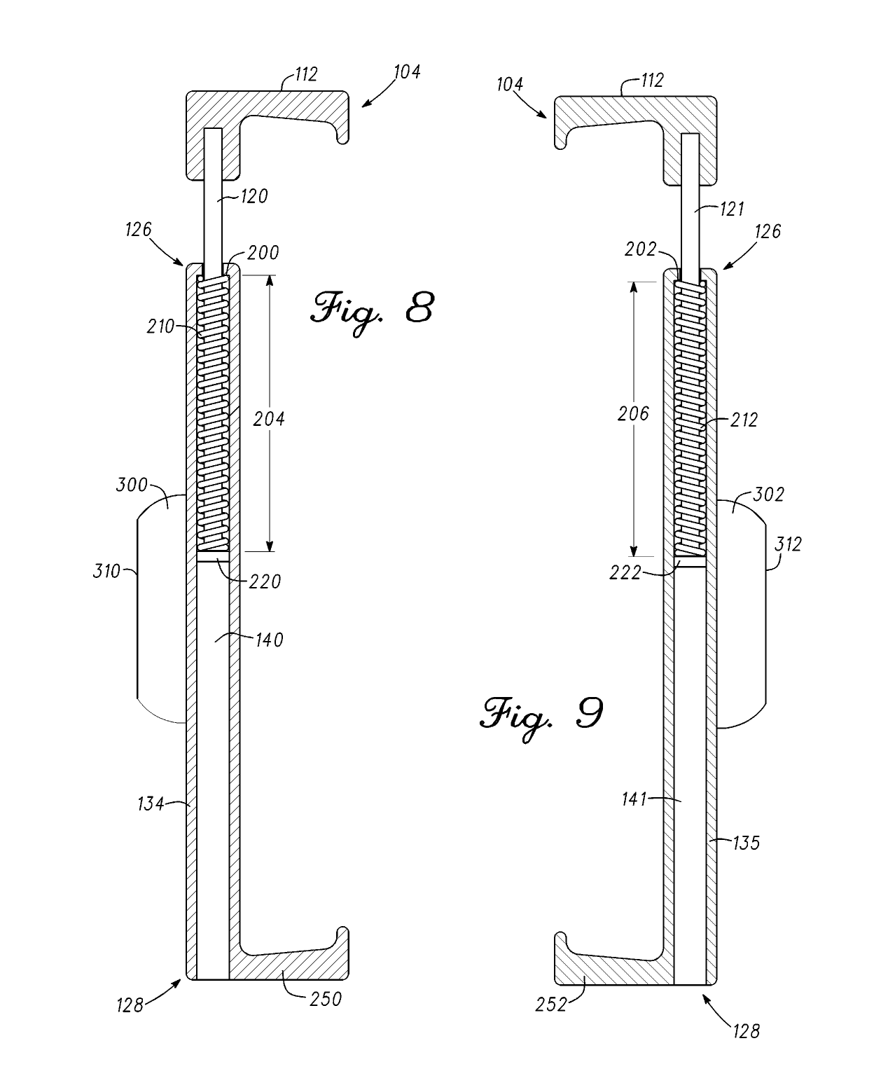

The first clamp portion 104 includes a first clamp body 110 and a first clamp arm 112 that is connected to the first clamp body 110 and extends transverse or generally perpendicular to the first clamp body 110. At the free end of the first clamp arm 112, the first clamp arm 112 includes a lip portion 114 extending generally transverse to the first clamp arm 112 and toward the second clamp portion 106. The first clamp body 110 includes a generally circular or curved channel 116 on a back side of the clamp body 110, which may be the side of the clamp body 110 that is opposite to the side of the first clamp body 110 to which the first clamp arm 112 is connected. The clamp body 110 includes a first rod attachment portion 118 and a second rod attachment portion 119, which may be located on opposite sides of the curved channel 116. A first rod 120 is attached to the first rod attachment portion 118 (shown in FIG. 8) and a second rod 121 is attached to the second rod attachment portion 119 (shown in FIG. 9). Accordingly, as shown in FIG. 1, two generally parallel and spaced apart rods 120 and 121 are attached to and extend from the first clamp body 110. The first rod 120 and the second rod 121 may be constructed with the clamp body 110 or constructed as separate pieces that are attached to the clamp body 110. For example, as shown in FIGS. 8 and 9, the first rod 120 and the second rod 121 may be separately constructed parts that are inserted into slots or bores of the first rod attachment portion 118 and the second rod attachment portion 119 and attached to the first rod attachment portion 118 and the second rod attachment portion 119, respectively. The first clamp portion 104 may include more than one clamp arm. For example the first clamp portion 104 may include a pair of spaced apart clamp arms (not shown). The methods, apparatus, and articles of manufacture described herein are not limited in this regard.

The body portion 102 includes a first end portion 126 and a second end portion 128. The first end portion 126 and the second end portion 128 may define a length of the body portion 102. The body portion 102 includes a front surface 130 that may extend from the first end portion 126 to the second end portion 128, and a generally curved channel 132 on a back portion 131, which is a portion of the body portion 102 that is behind the front surface 130. The body portion 102 further includes a first rod housing 134 and a second rod housing 135, which may be located on opposite sides of the curved channel 132 and extend along the length of the body portion 102. The first rod housing 134 includes a first rod passage 140 (shown in FIG. 8) that may be configured to accommodate a portion of the first rod 120 or the entire first rod 120. The second rod housing 135 includes a second rod passage 141 (shown in FIG. 9) that may be configured to accommodate a portion of second rod 121 or the entire second rod 121. Accordingly, the first clamp portion 104 may be movable from a position where the first clamp portion 104 abuts the body portion 102 and the first rod 120 and the second rod 121 are substantially inside the first rod passage 140 and the second rod passage 141, respectively, to a position where the first clamp portion 104 is spaced apart from the body portion 102 (shown for example in FIG. 1) and the first rod 120 and the second rod 121 are partially inside the first rod passage 140 and the second rod passage 141, respectively.

Referring to FIGS. 8 and 9, the first rod housing 134 includes a first aperture 200 at the first end portion 126. Portions of the first rod 120 may traverse in and out the first rod passage 140 through the first aperture 200. Similarly, the second rod housing 135 includes a second aperture 202 at the first end portion 126. Portions of the second rod 121 may traverse in and out of the second rod passage 141 through the second aperture 202. A diameter of each aperture 200 and 202 may be slightly greater than the outer diameter of the first rod 120 and the second rod 121, but is smaller than the inner diameter of the first rod passage 140 and the second rod passage 141, respectively. At a position along the first rod 120 or at the free end of the first rod 120, the first rod 120 includes a first stop 220, which may be cylindrical-shaped or disc-shaped. The stop 220 may have a diameter that is greater than the diameter of the first rod 120 and slightly smaller than the inner diameter of the first rod passage 140. Accordingly, a first annular passage 204 may be defined in the first rod passage 140 between the first stop 220 and the first aperture 200. Movement of the first rod 120 through the first rod passage 140 changes the length of the first annular passage 204. Similarly, at a position along the second rod 121 or at the free end of the second rod 121, the second rod 121 includes a second stop 222, which may be cylindrical-shaped or disc-shaped. The second stop 222 has a diameter that is greater than the diameter of the second rod 121 and slightly smaller than the inner diameter of the second rod passage 141. Accordingly, a second annular passage 206 may be defined in the second rod passage 141 between the second stop 222 and the second aperture 202. Movement of the second rod 121 through the second rod passage 141 changes the length of the second annular passage 206.

A first spring 210 is disposed in the first annular passage 204. The first spring 210 has a coil diameter that is smaller than the inner diameter of the first rod passage 140, greater than the diameter of the first aperture 200 and smaller than the diameter of the first stop 220. Accordingly, the first spring 210 is bound in the first annular passage 204. Similarly, a second spring 212 is disposed in the second annular passage 206. The second spring 212 has a coil diameter that is smaller than the inner diameter of the second passage 141, greater than the diameter of the second aperture 202 and smaller than the diameter of the second stop 222. Accordingly, the second spring 212 is bound inside the second annular passage 206.

Movement of the first rod 120 in the first rod passage 140 changes the length of the first annular passage 204. When the first rod 120 is moving in a direction out of the first rod passage 140, the first stop 220 compresses the first spring 210 against the first end portion 126 (i.e., around the first aperture 200) such that the first spring 210 exerts a force on the first stop 220 opposite to the movement of the first rod 120. When the first rod 120 is moving in a direction into the first rod passage 140, the first stop 220 allows the first spring 210 to decompress such that the force exerted by the spring on the first stop 220 is reduced.

Movement of the second rod 121 in the second rod passage 141 changes the length of the second annular passage 206. When the second rod 121 is moving in a direction out of the second rod passage 141, the second stop 222 compresses the second spring 212 against the first end portion 126 (i.e., around the second aperture 202) such that the second spring 212 exerts a force on the second stop 222 opposite to the movement of the second rod 121. When the second rod 121 is moving in a direction into the second rod passage 141, the second stop 222 allows the second spring 212 to decompress such that the force exerted by the spring on the second stop 222 is reduced.

The second clamp portion 106 (shown for example in FIGS. 1 and 2) includes a second clamp arm 250 and a third clamp arm 252 that may be spaced apart to collectively provide a sufficiently wide support for a portable electronic device such as the portable electronic device 1000. Each of the second clamp arm 250 and the third clamp arm 252 extends transversely from the body portion 102. The second clamp arm 250 may include a second lip portion 254 and the third clamp arm 252 may include a third lip portion 256. Each of the second lip portion 254 and the third lip portion 256 may extend toward the first clamp portion 104. The second clamp portion 106 may include a single clamp arm similar to the first clamp portion 104 or more than two clamp arms. Each clamp arm 250 and 252 may be fixed to the body portion 102 or be movable relative to the body portion 102 similar to the first clamp arm 112 of the first clamp portion 104. The methods, apparatus, and articles of manufacture described herein are not limited in this regard.

When the first clamp portion 104 is abutting the body portion 102, the first spring 210 and the second spring 212 may be compressed. Accordingly, the first clamp portion 104 may be pressed and maintained against the body portion 102 by the forces of the first spring 210 and the second spring 212. When the first clamp portion 104 is moved or pulled away from the body portion 102, a portion of the first rod 120 and a portion of the second rod 121 are moved out of the first passage 140 and the second passage 141 to reduce the length of the first annular passage 204 and the second annular passage 206, respectively. Accordingly, the first spring 210 and the second spring 212 are further compressed in the first annular passage 204 and the second annular passage 206 to increase the forces in the first spring 210 and the second spring 212, respectively. The first clamp portion 104 may be further moved or pulled away from the body portion 102 until the first spring 210 and the second spring 212 are fully compressed, i.e., can no longer be compressed. Thus, the first clamp portion 104 may be moved to any position from an initial position where the first clamp portion 104 is pressed against the body portion 102 and the springs 210 and 212 are compressed to a final position where the first spring 210 and the second spring 212 are fully compressed. The forces of the first spring 210 and the second spring 212 return the first clamp portion 104 to the initial position from any position between the initial position and the final position. The initial position of the first clamp portion 104 may define the smallest distance between the first clamp arm 112 and the second and third clamp arms 250 and 252. The final position of the first clamp portion 104 may define the largest distance between the first clamp arm 112 and the second and third clamp arms 250 and 252.

According to another embodiment, when the first clamp portion 104 is abutting the body portion 102, i.e., the initial position, the first spring 210 and the second spring 212 may be expanded. The springs 210 and 212 may be positioned in the first rod passage 140 and the second rod passage 141 between the second end portion 106 and the stops 220 and 222, respectively (not shown). The springs 210 and 212 are further expanded when the first clamp portion 104 is moved to any position from the initial position to the final position. The final position of the first clamp portion 104 may correspond to a position where the stops 220 and 222 contact the first end portion 104 (not shown).

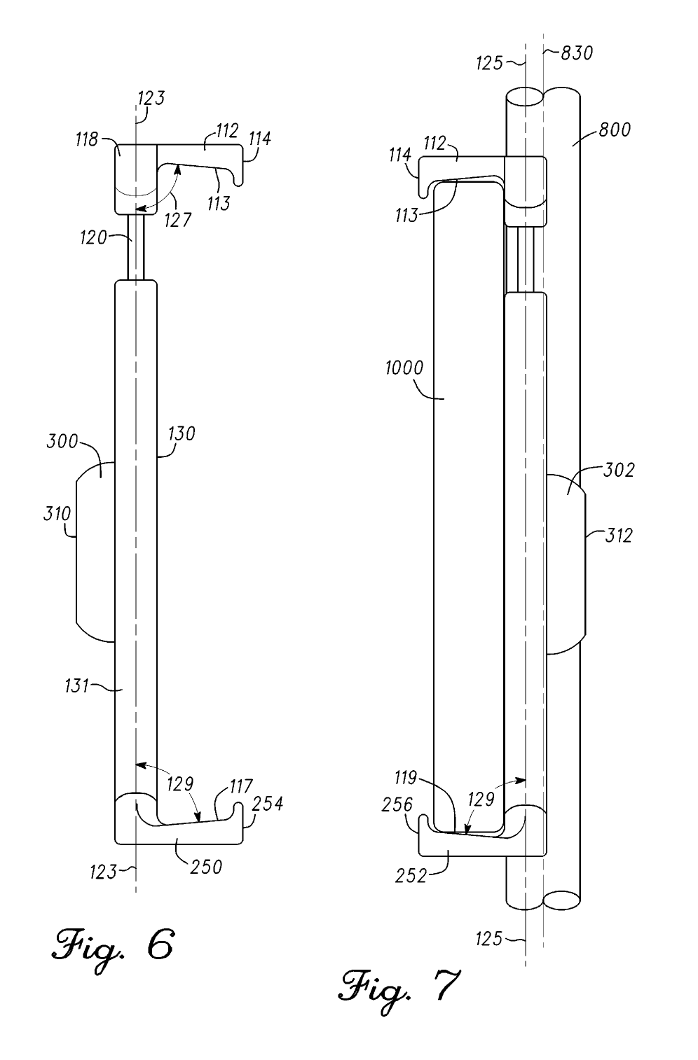

The portable electronic device holder 100 can hold a portable electronic device between the first clamp arm 112 and the second and third clamp arms 250 and 252 by the clamp arms 112, 250 and 252 pressing on opposing surfaces, portions or sides of the portable electronic device with the forces of the first spring 210 and the second spring 212. Referring to FIGS. 6 and 7, a first inner surface 113 of the first clamp arm 112 may define an acute angle 127 with the direction of the forces exerted on the first clamp portion 104 by the springs 210 and 212. In FIGS. 6 and 7, the forces exerted on the first clamp portion 104 by the springs are shown to be generally in the same direction as the longitudinal axis 123 of the first rod 120 and/or the longitudinal axis 125 of the second rod 121. In other words, the first inner surface 113 is downwardly inclined relative to the body portion 102. Similarly, the second inner surface 117 of the second clamp arm 250 and the third inner surface 119 of the third clamp arm 252 may define an acute angle 129 with the longitudinal axis 123 and/or the longitudinal axis 125. In other words, the second inner surface 117 and the third inner surface 119 are upwardly inclined relative to the body portion 102. When the portable electronic device 1000 is pressed by the first inner surface 113, the second inner surface 117 and the third inner surface 119, the acute angles 127 and 129 cause a component of force to be exerted on the portable electronic device 1000 in a direction toward the body portion 102. Thus, as the first clamp arm 112 and the second and third clamp arms 250 and 252 press on opposing surfaces, portions or sides of the portable electronic device 1000, the portable electronic device may be pushed and/or maintained against the front surface 130 of the body portion 102.

Portable electronic devices of varying sizes may be held by the portable electronic device holder 100 by moving the first clamp portion 104 between the initial position and the final position to increase or decrease the distance between the first clamp arm 112 and the second and third clamp arms 250 and 252. For example, referring to FIG. 10, a rectangular portable electronic device 1000 may be held by the first clamp arm 112 and the second and third clamp arms 250 and 252 pressing against two opposing sides 1002 and 1004 of the portable electronic device 1000. Alternatively, the portable electronic device 1000 may be held by the first clamp arm 112 and the second and third clamp arms 250 and 252 pressing against the two opposing sides 1006 and 1008 of the portable electronic device 1000 (not shown). In another example, a circular portable electronic device (not shown) may be held with the portable electronic device holder 100 by the first clamp arm 112 and the second and third clamp arms 250 and 252 engaging radially opposing perimeter edges, surfaces and/or portions of the circular electronic device. Accordingly, a portable electronic device having any shape may be held by the portable electronic device holder 100 as long as two opposing sides, surfaces and/or portions of the portable electronic device can be engaged and held by the first clamp arm 112 and the second and third clamp arms 250 and 252.

A portable electronic device 1000 may be mounted on to the portable electronic device holder 100 by pulling the first clamp portion 104 away from the body portion 102 until the distance between the first lip portion 114 and the second and third lip portions 254 and 256 is greater than a distance between two opposing edges, surfaces and/or portions of the portable electronic device. The portable electronic device 1000 may then be inserted into the portable electronic device holder 100 by the back portion 1012 being moved toward the front surface 130 until the back portion 1012 abuts the front surface 130 and the bottom portion 1002 rests on the second and third clamp arms 250 and 252. The first clamp arm 112 may then be released or moved toward the body portion 102 so that the first clamp arm 112 engages the second side 1004 of the portable electronic device. Alternatively, the first clamp portion 104 may be pulled away from the body portion 102 until the distance between the first clamp arm 112 and the second and third clamp arms 250 and 252 is greater than a distance between two opposing edges, surfaces and/or portions of the portable electronic device 1000. The portable electronic device 1000 may then be inserted into the portable electronic device holder 100 by being slipped in-between the first clamp arm 112 and the second and third clamp arms 250 and 252 (i.e., the back portion 1012 being moved generally parallel to the front surface 130) and the bottom portion 1002 being rested on the second and third clamp arms 250 and 252. The first clamp arm 112 may then be released or moved toward the body portion 102 so that the first clamp arm 112 engages the top portion 1004 of the portable electronic device.

The forces generated by the compression of the first spring 210 and the second spring 212 cause the first clamp arm 112 and the second and third clamp arms 252 and 254 to press against the portable electronic device 1000 and frictionally hold the portable electronic device 1000 in the portable electronic device holder 100. The first clamp arm 112 and/or the second and third clamp arms 250 and 252 may include a frictional material and/or surface texture that may enhance the frictional engagement between the clamp arms 112, 250 and 252 and the portable electronic device 1000. For example, each of the clamp arms 112, 250 and 252 may include a rubber or high density foam pad that engages the portable electronic device 1000. According to another example, the portion of each of the clamp arms 112, 250 and 252 that engages the portable electronic device 1000 may have a certain texture that enhances the frictional engagement with the portable electronic device 1000.

The first lip portion 114 and the second and third lip portions 254 and 256 may engage a front surface or the display portion 1010 of the portable electronic device 1000 to further assist in holding the portable electronic device 1000 in the portable electronic device holder 100. To remove the portable electronic device 1000 from the portable electronic device holder 100, the first clamp portion 104 may be moved or pulled away from the body portion 102 so that the first clamp arm 112 is sufficiently spaced from the first side 1002 of the portable electronic device 1000 to allow removal of the portable electronic device 1000 from the portable electronic device holder 100.

The portable electronic device holder 100 may be mounted on a shaft of sports equipment or any cylindrical object. Referring to FIGS. 2-5, 7 and 10, the portable electronic device holder 100 may be mounted on a golf club shaft 800. The portable electronic device holder 100 may engage the golf club shaft 800 at any location on the golf club shaft 800. The curved channel 132 of the body portion 102 is located opposite to the front surface 130. Additionally, the curved channel 116 of the first clamp portion 104 may be linearly aligned with the curved channel 132 of the body portion 102. The curved channels 132 and 116 collectively define an elongated substantially linear channel having a concave curvature relative to the front surface 130. Furthermore, the length of the channel defined by the curved channel 132 and the curved channel 116 can increase or decrease based on the position of the first clamp portion 104 relative to the body portion 102. The curved channels 132 and 116 can receive a longitudinal portion of a shaft such as a golf club shaft 800. The channels 132 and 116 may be tapered from the first clamp portion 104 to the second end portion 106 to generally correspond to a taper in the golf club shaft 800. For example, the diameter of the golf club shaft 800 may decrease from the grip portion (not shown) to the head portion (not shown). Accordingly, the diameter or width of the channels 132 and 116 may decrease from the first clamp portion 104 to the second end portion 106. The channels 132 and 116 may have any dimensional variation from the first clamp portion 104 to the second end portion 106 to correspond to a similar dimensional variation in the golf club shaft 800. Although the channels 132 and 116 are described and shown as curved channels, the channels 132 and 116 may have any shape that corresponds to the shape of a certain shaft. For example, the channels 132 and 116 may have an oval shape to receive a shaft having an oval cross section. In another example, the channels 132 and 116 may have a triangular shape to receive a shaft having a triangular shape. The methods, apparatus, and articles of manufacture described herein are not limited in this regard.

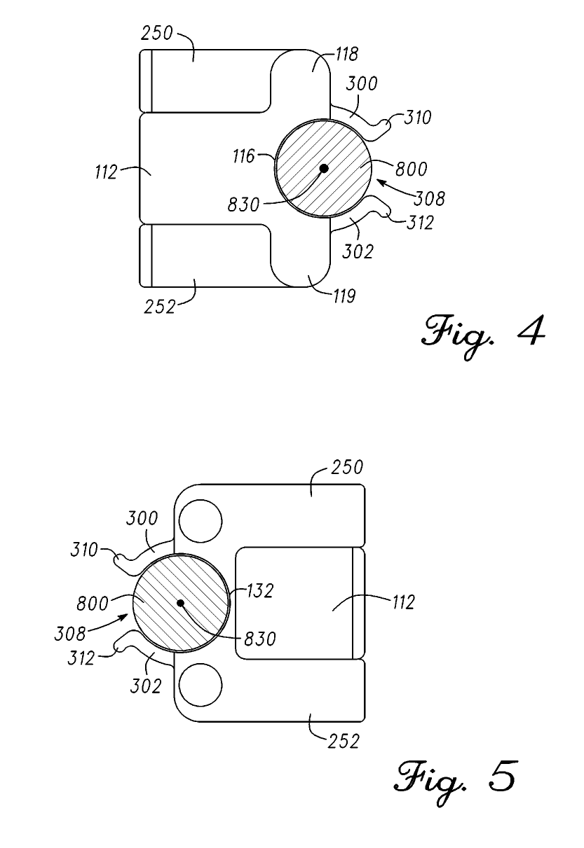

Referring to FIGS. 2-7, the portable electronic device holder 100 may further include at least a pair of arms 300 and 302 that are spaced apart and disposed on opposite sides of the channel 132. The arms 300 and 302 and the curved channel 132 may collectively define a generally cylindrical passage 306 for receiving a portion of the golf club shaft 800 through an opening 308 that is defined by the space between the arms 300 and 302. According to one example, the arms 300 and 302 may be shaped to substantially continue the curvature of the curved channel 132. For example, as shown in FIGS. 4 and 5, if the cross section of the channel 132 defines a radial portion of a circle, then the arms 300 and 302 may define other radial portions of the same circle. Movement of the arms 300 and 302 from a rest position to widen or narrow the opening 308 can elastically bend the body portion 102, e.g., widen or narrow the channel 132. Accordingly, the elastic bending of the body portion 102 provides a biasing force for returning the arms 300 and 302 to the rest position. Alternatively, the arms 300 and 302 may be elastically flexible and/or be flexibly attached to the body portion 102. Each arm 300 and 302 may also include an expansion tab 310 and 312 that may extend along at least a portion of the arm 300 and 302, respectively. Each expansion tab 310 and 312 extends outwardly from the corresponding arm 300 and 302 to effectively enlarge the opening 308.

The generally transverse orientation of each expansion tab 310 and 312 relative to a corresponding direction of the arm 300 and 302, respectively, provides for the elastic bending of the arms 300 and 302, the channel 132 and/or the body portion 102 when a golf club shaft 800 is pressed against the expansion tabs 310 and 312. Accordingly, when a golf club shaft 800 is pressed against the expansion tabs 310 and 312, the golf club shaft 800 presses the expansion tabs 310 and 312 outward to elastically enlarge the opening 308 so that the golf club shaft 800 may be received in the cylindrical passage 306. Upon the golf club shaft 800 being inserted in the cylindrical passage 306, the elastic restoring force of the arms 300 and 302, the channel 132 and/or the body portion 102 move or snap the arms 300 and 302 back toward the pre-expanded position to frictionally engage the golf club shaft 800 in cooperation with the curved channel 132. The curved channel 132 and or the arms 300 and 302 may collectively define a partial oval cross-sectional shape, circular cross-sectional shape, rectangular cross-sectional shape, or any other shape that may be similar to correspondingly shaped shaft. The methods, apparatus, and articles of manufacture described herein are not limited in this regard.

A portable electronic device may be mounted on the golf club shaft 800 with the portable electronic device holder 100 to capture still and/or video images of an area around the portable electronic device; measure and/or determine relative and/or absolute linear motion, velocity and/or acceleration of the portable electronic device; measure and/or determine relative and/or absolute angular motion, velocity and/or acceleration of the portable electronic device; and/or measure and/or determine relative and/or absolute position of the portable electronic device. Referring to FIGS. 4, 5 and 7, the curved channel 132 and the curved channel 116 allow the axis 830 of the golf club shaft 800 to be located close to the front surface 130 of the portable electronic device holder 100, hence close to the portable electronic device 1000 when the portable electronic device 1000 is attached to the golf club shaft 800 with the portable electronic device holder 100. Accordingly, any of the above-described motion, velocity, acceleration and/or position measurements and/or determinations associated with the portable electronic device 1000 may be interpreted as motion, velocity, acceleration and/or position measurements and/or determinations associated with the golf club shaft 800. The distance 330 (shown in FIG. 1) between the bottom of the curved channel 132 and the front surface 130 (i.e., the smallest thickness of the material between the front surface 130 and the lowest point on the curved channel 132) may be optimally minimized based on the materials and/or methods of construction of the portable electronic device holder 100. For example, for a device holder constructed from a highly rigid material such as titanium, the distance may be smaller than a device holder constructed from a less rigid material such as plastic. Thus, the size and curvature of the curved channel 132 and the distance 330 may be optimally determined to place the axis 830 of the golf club shaft 800 as close as possible to the portable electronic device 1000.

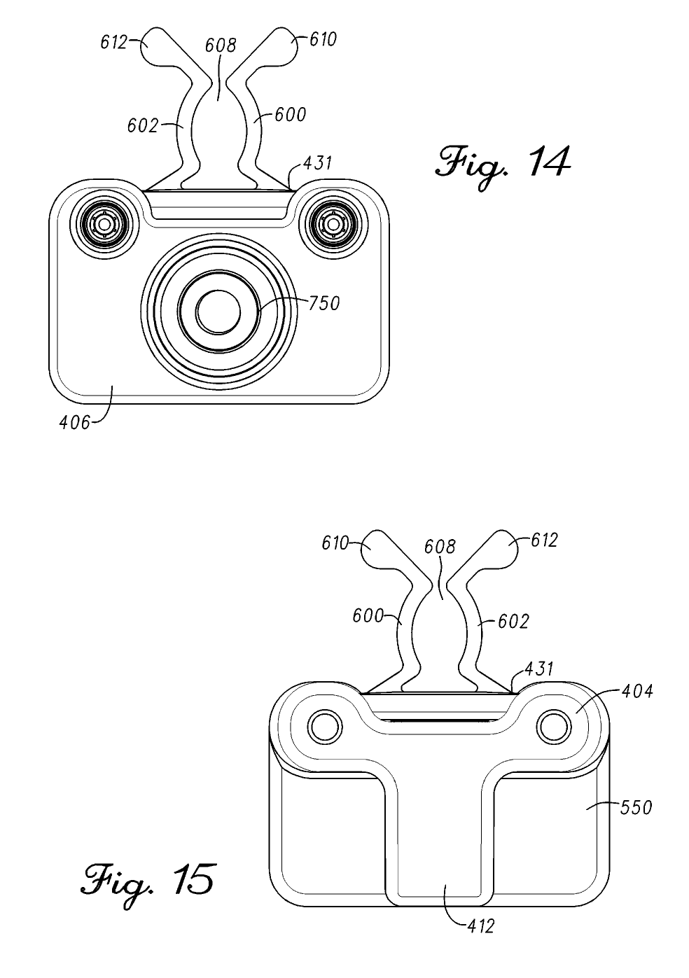

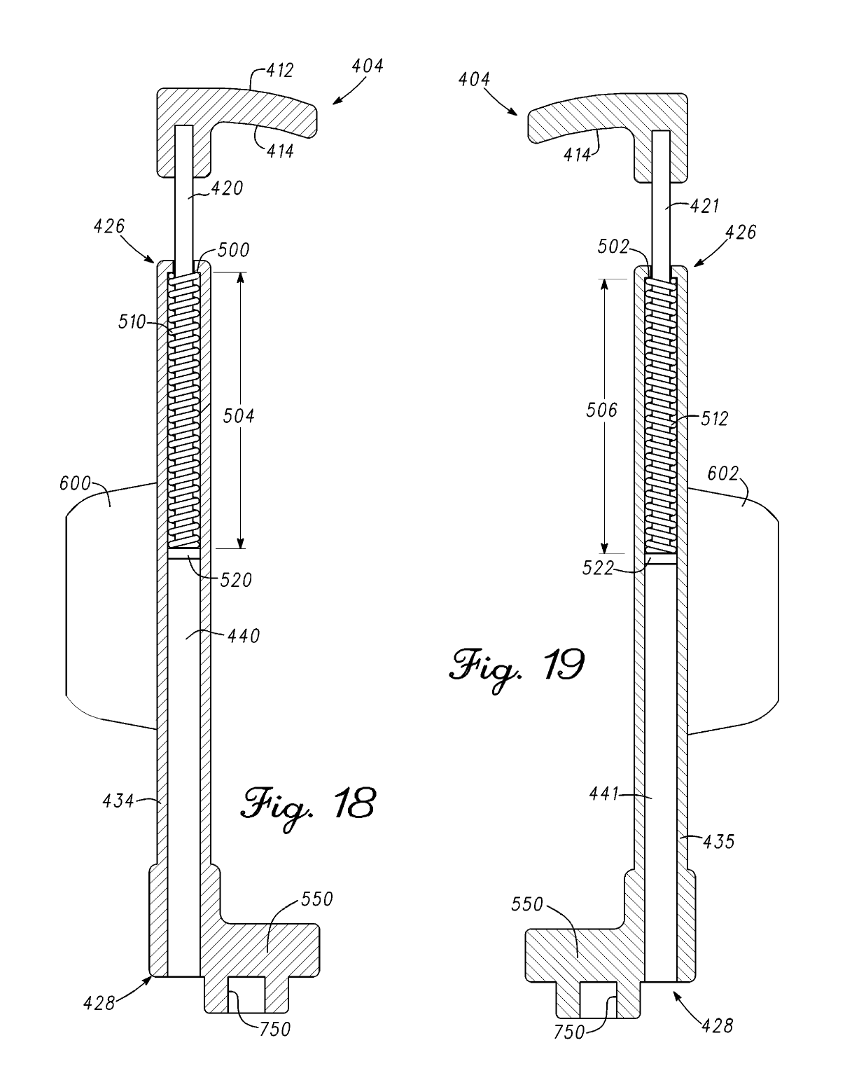

FIGS. 12-20 illustrate another exemplary embodiment of the portable electronic device holder 400. Portable electronic device holder 400 may be similar to portable electronic device holder 100, with like numbers referencing similar components. The portable electronic device holder 400 may include a body portion 402, a first clamp portion 404 and a second clamp portion 406. The portable electronic device holder 400 may be configured to removably attach a portable electronic device 1000 such as a wireless communication device and/or a portable media player to a golf club shaft 800 (generally shown in FIGS. 17 and 18) of a golf club (e.g., a putter-type golf club), similar to the portable electronic device holder 100. Accordingly, first clamp portion 404 and a second clamp portion 406 may be configured to provide engagement with any portable electronic device. The apparatus and articles of manufacture described herein are not limited in this regard.

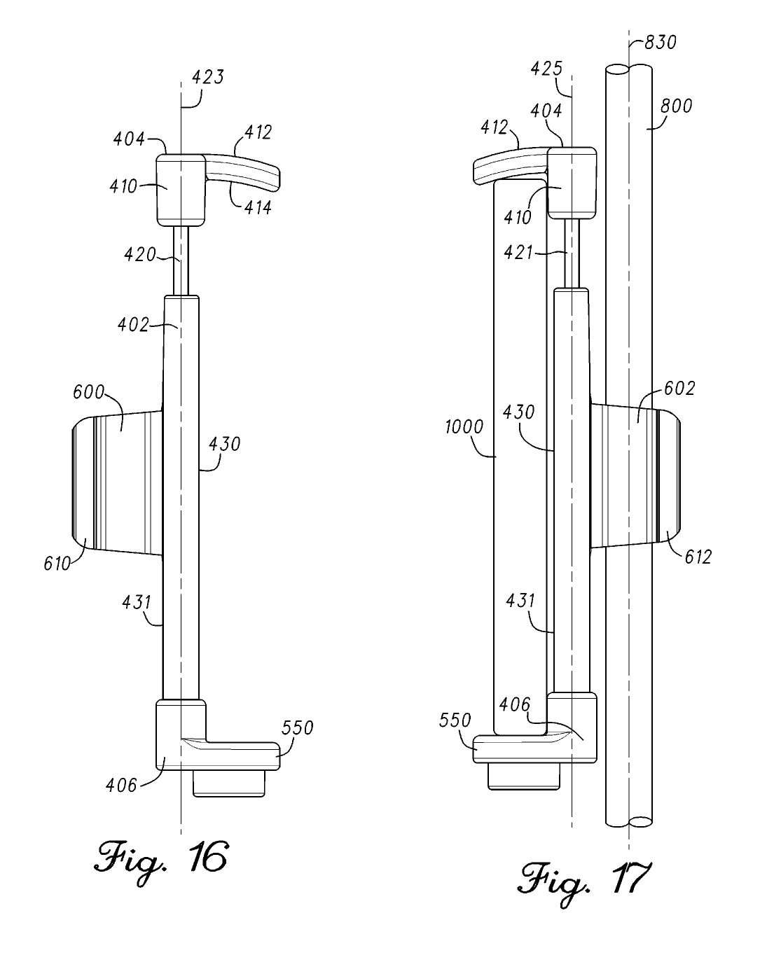

The first clamp portion 404 includes a first clamp body 410 and a first clamp arm 412 that is connected to the first clamp body 410 and extends substantially transverse to the first clamp body 410. The first clamp arm 412 has an arcuate shape defining a curved surface 414 (see FIG. 16). The curved surface 414 allows the free end of the first clamp arm 412 to extend toward the second clamp portion 406 such that the free end of the first clamp arm 412 is closer to the second clamp portion 406 than the attached end of the first clamp arm 412.

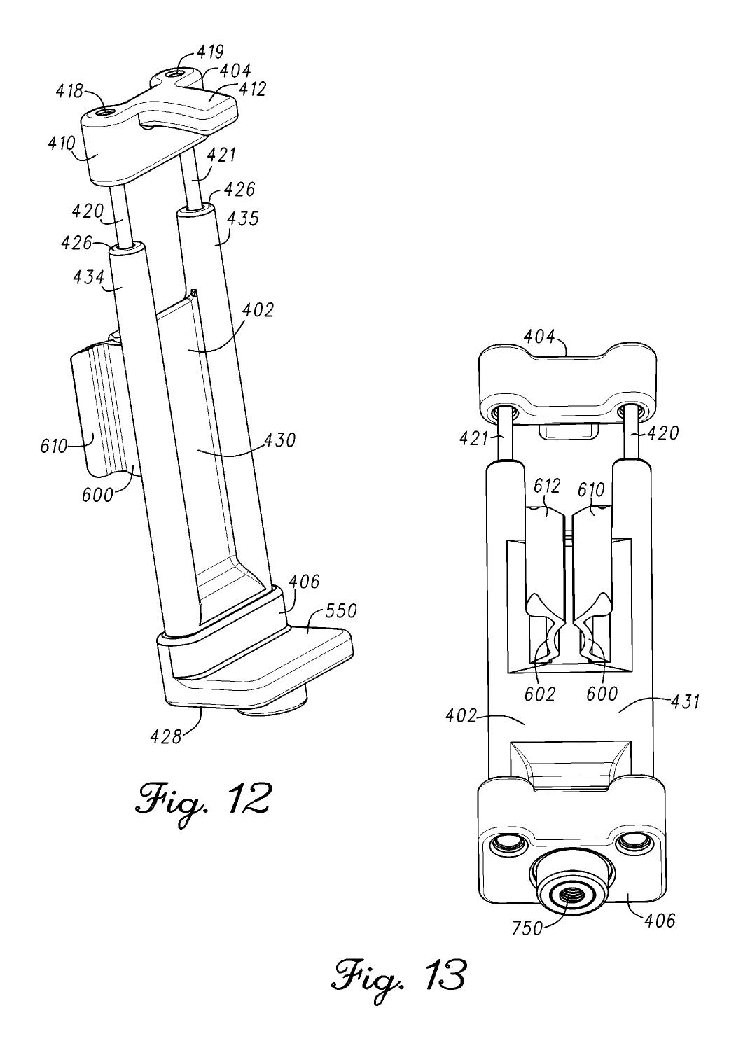

The clamp body 410 includes a first rod attachment portion 418 and a second rod attachment portion 419. A first rod 420 is attached to the first rod attachment portion 418 and a second rod 421 is attached to the second rod attachment portion 419 (shown in FIG. 12). Accordingly, as shown in FIG. 12, two generally parallel and spaced apart rods 420 and 421 are attached to and extend from the first clamp body 410. The first rod 420 and the second rod 421 may be constructed with the clamp body 410 or constructed as separate pieces that are attached to the clamp body 410. For example, as shown in FIGS. 12 and 13, the first rod 420 and the second rod 421 may be separately constructed parts that are inserted into slots or bores of the first rod attachment portion 418 and the second rod attachment portion 419 and attached to the first rod attachment portion 418 and the second rod attachment portion 419, respectively. In the illustrated embodiment, the first clamp portion 404 includes the first clamp arm 412. In other embodiments, the first clamp portion 404 may include more than one clamp arm. For example, the first clamp portion 404 may include a pair of spaced apart clamp arms (not shown). The methods, apparatus, and articles of manufacture described herein are not limited in this regard.

The body portion 402 includes a first end portion 426 and a second end portion 428. The first end portion 426 and the second end portion 428 may define a length of the body portion 402. The body portion 402 includes a front surface 430 and a back surface 431 that may extend from the first end portion 426 to the second end portion 428. The body portion 402 further includes a first rod housing 434 and a second rod housing 435, which may extend along the length of the body portion 402. The first rod housing 434 includes a first rod passage 440 (FIG. 18) that is configured to accommodate a portion of the first rod 420 or the entire first rod 420. The second rod housing 435 includes a second rod passage 441 (FIG. 19) that is configured to accommodate a portion of second rod 421 or the entire second rod 421. Accordingly, the first clamp portion 404 may be movable from a position where the first clamp portion 404 abuts the body portion 402 and the first rod 420 and the second rod 421 are substantially inside the first rod passage 440 and the second rod passage 441, respectively, to a position where the first clamp portion 404 is spaced apart from the body portion 402 (shown for example in FIG. 12). The first rod 420 and the second rod 421 are partially inside the first rod passage 440 and the second rod passage 441, respectively.

Referring to FIGS. 18 and 19, the first rod housing 434 includes a first aperture 500 at the first end portion 426. Portions of the first rod 420 may traverse in and out the first rod passage 440 through the first aperture 500. Similarly, the second rod housing 435 includes a second aperture 502 at the first end portion 426. Portions of the second rod 421 may traverse in and out of the second rod passage 441 through the second aperture 502. A diameter of each aperture 500, 502 may be slightly greater than the outer diameter of the first rod 420 and the second rod 421, but smaller than the inner diameter of the first rod passage 440 and the second rod passage 441, respectively. At a position along the first rod 420 or at the free end of the first rod 420, the first rod 420 includes a first stop 520 which may be cylindrical-shaped or disc-shaped. The first stop 520 may have a diameter that is greater than the diameter of the first rod 420 and slightly smaller than the inner diameter of the first rod passage 440. Accordingly, a first annular passage 504 may be defined in the first rod passage 440 between the first stop 520 and the first aperture 500. Movement of the first rod 420 through the first rod passage 440 changes the length of the first annular passage 504. Similarly, at a position along the second rod 421 or at the free end of the second rod 421, the second rod 421 includes a second stop 522 which may be cylindrical-shaped or disc-shaped. The second stop 522 has a diameter that is greater than the diameter of the second rod 421 and slightly smaller than the inner diameter of the second rod passage 441. Accordingly, a second annular passage 506 may be defined in the second rod passage 441 between the second stop 522 and the second aperture 502. Movement of the second rod 421 through the second rod passage 441 changes the length of the second annular passage 506.

A first spring 510 is disposed in the first annular passage 504. The first spring 510 has a coil diameter that is smaller than the inner diameter of the first rod passage 440, greater than the diameter of the first aperture 500 and smaller than the diameter of the first stop 520. Accordingly, the first spring 510 is bound in the first annular passage 504. Similarly, a second spring 512 is disposed in the second annular passage 506. The second spring 512 has a coil diameter that is smaller than the inner diameter of the second rod passage 441, greater than the diameter of the second aperture 502 and smaller than the diameter of the second stop 522. Accordingly, the second spring 512 is bound inside the second annular passage 506.

Movement of the first rod 420 in the first rod passage 440 changes the length of the first annular passage 504. When the first rod 420 is moving in a direction out of the first rod passage 504, the first stop 520 compresses the first spring 510 against the first end portion 426 (i.e., around the first aperture) such that the first spring 510 exerts a force on the first stop 520 opposite to the movement of the first rod 420. When the first rod 420 is moving in a direction into the first rod passage 440, the first stop 520 allows the first spring 510 to decompress such that the force exerted by the first spring 510 on the first stop 520 is reduced.

Movement of the second rod 421 in the second rod passage 441 changes the length of the second annular passage 506. When the second rod 421 is moving in a direction out of the second rod passage 441, the second stop 522 compresses the second spring 512 against the first end portion 426 (i.e., around the second aperture) such that the second spring 512 exerts a force on the second stop 522 opposite to the movement of the second rod 421. When the second rod 421 is moving in a direction into the second rod passage 441, the second stop 522 allows the second spring 512 to decompress such that the force exerted by the second spring 512 on the second stop 522 is reduced.

Referring to FIG. 12, the second clamp portion 406 includes a second clamp arm 550 that extends transversely from the body portion 402. In other embodiments, the second clamp portion 406 may include more than one clamp arm. For example, the second clamp portion 406 may include a pair of spaced apart clamp arms (not shown). Further, in the illustrated embodiment, the second clamp arm 406 is substantially perpendicular to the body portion 402, thereby allowing the portable electronic device holder 400 to receive a portable electronic device of any width and thickness. The methods, apparatus, and articles of manufacture described herein are not limited in this regard.

When the first clamp portion 404 is abutting the body portion 402, the first spring 510 and the second spring 512 may be compressed. Accordingly, the first clamp portion 404 may be pressed and maintained against the body portion 402 by the forces of the first spring 510 and the second spring 512. When the first clamp portion 404 is moved or pulled away from the body portion 402, a portion of the first rod 420 and a portion of the second rod 421 are moved out of the first rod passage 440 and the second rod passage 441 to reduce the length of the first annular passage 504 and the second annular passage 506, respectively. Accordingly, the first spring 510 and the second spring 512 are further compressed in the first annular passage 504 and the second annular passage 506 to increase the forces in the first spring 510 and the second spring 512, respectively. The first clamp portion 404 may be further moved or pulled away from the body portion 402 until the first spring 510 and the second spring 512 are fully compressed, i.e., can no longer be compressed. Thus, the first clamp portion 404 may be moved to any position from an initial position where the first clamp portion 404 is pressed against the body portion 402 and the springs 510, 512 are compressed to a final position where the first spring 510 and the second spring 512 are fully compressed. The forces of the first spring 510 and the second spring 512 return the first clamp portion 404 to the initial position from any position between the initial position and the final position. The initial position of the first clamp portion 404 may define the smallest distance between the first clamp arm 412 and the second clamp arm 550. The final position of the first clamp portion 404 may define the largest distance between the first clamp arm 412 and the second clamp arm 550.

According to another embodiment, when the first clamp portion 404 is abutting the body portion 402, i.e., the initial position, the first spring 510 and the second spring 512 may be expanded. The springs 510, 512 may be positioned in the first rod passage 440 and the second rod passage 441 between the second end portion 406 and the first and second stops, 520, 522, respectively (not shown). The springs 510, 512 are further expanded when the first clamp portion 404 is moved to any position from the initial position to the final position. The final position of the first clamp portion 404 may correspond to a position where the stops 520, 522 contact the first end portion 404 (not shown).

The portable electronic device holder 400 can hold a portable electronic device 1000 between the first clamp arm 412 and the second clamp arm 550 by the clamp arms 412 and 550 pressing on opposing surfaces, portions or sides of the portable electronic device 1000 with the forces of the first spring 510 and the second spring 512. The forces exerted on the first clamp portion 404 by the first and the second spring 510, 512 are generally in the same direction as a longitudinal axis 423 (FIG. 16) of the first rod 420 and/or a longitudinal axis 425 (FIG. 17) of the second rod 421. The longitudinal forces exerted on the first clamp portion 404 by the springs 510, 512 aid in securing the portable electronic device 1000 within the portable electronic device holder 400 by preventing the portable electronic device 1000 from moving relative to the portable electronic device holder 400 in the direction of the longitudinal forces, due to the springs 510, 512. Thus, as the first clamp arm 412 and the second clamp arm 550 press on opposing surfaces, portions or sides of the portable electronic device 1000, the portable electronic device 1000 may be pushed, maintained, and/or secured between the first clamp portion 404 and the second clamp portion 406. Further, the curved surface 414 exerts a force generally perpendicular to the longitudinal axis 423 (FIG. 16) of the first rod 420 and/or the longitudinal axis 425 (FIG. 17) of the second rod 421, thereby further securing the portable electronic device 1000 in the portable electronic device holder 400 by preventing the portable electronic device 1000 from moving relative to the portable electronic device holder 400 in a direction of the perpendicular force, due to the downward inclination of the curved surface 414 relative to the body portion 402. When the portable electronic device 1000 is pressed by the first clamp arm 412 and the second clamp arm 550, the curved surface 414 exert a component of force on the portable electronic device 1000 in a direction toward the body portion 402. Therefore, the curved surface 414 of the portable electronic device holder 400 provides the same function as the first lip portion 114, the second lip portion 254, and the third lip portion 256 of the portable electronic device holder 100. In other words, the curved surface 414 and the first, the second and the third lip portions 114, 254, 256 all secure the portable electronic device 1000 within the portable electronic device holder by preventing movement of the portable electronic device 1000 relative to the portable electronic device holder in a direction generally perpendicular to the longitudinal axes 123, 423, 125, 425 and/or the front surface 430 of the body portion 402.

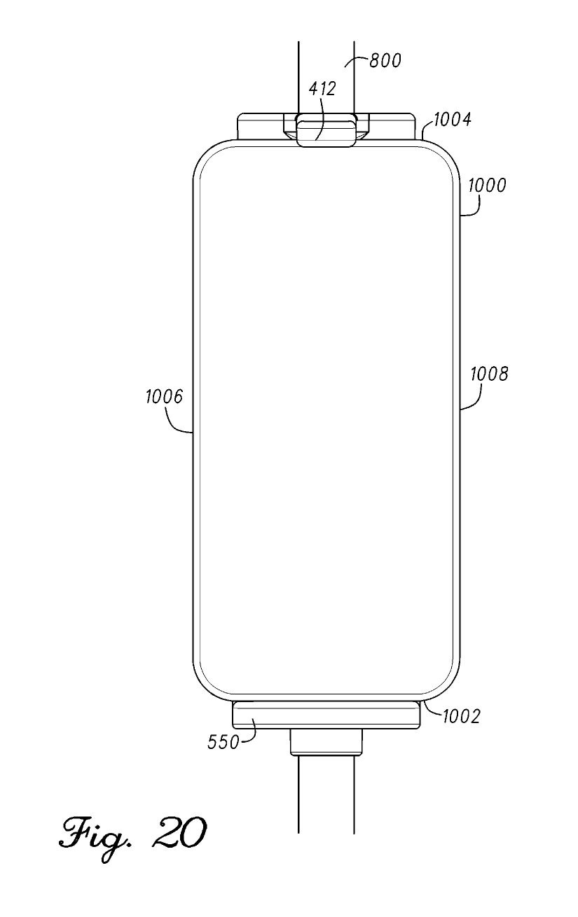

Portable electronic devices of varying sizes may be held by the portable electronic device holder 400 by moving the first clamp portion 404 between the initial position and the final position to increase or decrease the distance between the first clamp arm 412 and the second clamp arm 550. For example, referring to FIG. 20, a rectangular portable electronic device 1000 may be held by the first clamp arm 412 and the second clamp arm 550 pressing against two opposing sides 1002 and 1004 of the portable electronic device 1000. Alternatively, the portable electronic device 1000 may be held by the first clamp arm 412 and the second clamp arm 550 pressing against the two opposing sides 1006 and 1008 of the portable electronic device 1000 (not shown). In another example, a circular portable electronic device (not shown) may be held with the portable electronic device holder 100 by the first clamp arm 412 and the second clamp arm 550 engaging radially opposing perimeter edges, surfaces and/or portions of the circular electronic device. Accordingly, a portable electronic device having any shape may be held by the portable electronic device holder 400 as long as two opposing sides, surfaces and/or portions of the portable electronic device can be engaged and held by the first clamp arm 412 and the second clamp arm 550.

A portable electronic device 1000 may be mounted on to the portable electronic device holder 100 by pulling the first clamp portion 404 away from the body portion 402 until the distance between the first clamp arm 412 and the second clamp arm 550 is greater than a distance between two opposing edges, surfaces and/or portions of the portable electronic device. The portable electronic device 1000 may then be inserted into the portable electronic device holder 400 by the back portion (not shown) being moved toward the front surface 430 until the bottom portion 1002 rests on the second clamp arm 550. The first clamp arm 412 may then be released or moved toward the body portion 402 so that the first clamp arm 412 engages the second side 1004 of the portable electronic device. Alternatively, the first clamp portion 404 may be pulled away from the body portion 402 until the distance between the first clamp arm 412 and the second clamp arm 550 is greater than a distance between two opposing edges, surfaces and/or portions of the portable electronic device 1000. The portable electronic device 1000 may then be inserted into the portable electronic device holder 400 by being slipped in-between the first clamp arm 412 and the second clamp arm 550 (i.e., the back portion being moved generally parallel to the front surface 430) and the bottom portion 1002 being rested on the second clamp arm 550. The first clamp arm 412 may then be released or moved toward the body portion 402 so that the first clamp arm 412 engages the top portion 1004 of the portable electronic device.

The forces generated by the compression of the first spring 510 and the second spring 512 cause the first clamp arm 412 and the second clamp arm 550 to press against the portable electronic device 1000 and frictionally hold the portable electronic device 1000 in the portable electronic device holder 400. The longitudinal forces exerted on the first clamp portion 404 by the springs 510, 512 aid in securing the portable electronic device 1000 within the portable electronic device holder 400 by preventing the portable electronic device 1000 from moving relative to the portable electronic device holder 400 in the direction of the longitudinal forces, due to the springs 510, 512. Further, the curved surface 414 exerts a force generally perpendicular to the longitudinal axis 423 (FIG. 16) of the first rod 420 and/or the longitudinal axis 425 (FIG. 17) of the second rod 421, thereby further securing the portable electronic device 1000 in the portable electronic device holder 400 by preventing the portable electronic device 1000 from moving relative to the portable electronic device holder 400 in a direction of the perpendicular force, due to the downward inclination of the curved surface 414 relative to the body portion 402. The first clamp arm 412 and/or the second clamp arm 550 may include a frictional material and/or surface texture that may enhance the frictional engagement between the clamp arms 412, 550 and the portable electronic device 1000 and/or provide vibration damping and sound reduction during use. For example, each of the clamp arms 412, 550 may include a rubber or high density foam pad that engages the portable electronic device 1000. According to another example, the portion of each of the clamp arms 412, 550 that engages the portable electronic device 1000 may have a certain texture that enhances the frictional engagement with the portable electronic device 1000.

To remove the portable electronic device 1000 from the portable electronic device holder 400, the first clamp portion 404 may be moved or pulled away from the body portion 402 so that the first clamp arm 412 is sufficiently spaced from the first side 1002 of the portable electronic device 1000 to allow removal of the portable electronic device 1000 from the portable electronic device holder 400.

Referring to FIGS. 13-15, the portable electronic device holder 400 may further include at least a pair of arms including a first arm 600 and a second arm 602 that are spaced apart and positioned on the back surface 431 of the body portion 402. The arms 600 and 602 may be fixedly attached to the back surface 431 of the body portion 402. The arms 600 and 602 define an opening 608 capable of expanding to receive a portion of the golf club shaft 800. The arms 600 and 602 may be elastically flexible and/or be flexibly attached to the body portion 402. Each arm 600 and 602 may also include an expansion tab 610 and 612 that may extend along at least a portion of the arm 600 and 602, respectively. Each expansion tab 610 and 612 extends outwardly from the corresponding arm 600 and 602 to effectively enlarge the opening 608.

The generally transverse orientation of each expansion tab 610 and 612 relative to a corresponding direction of the arm 600 and 602, respectively, provides for the elastic bending of the arms 600 and 602 when a golf club shaft 800 is pressed against the expansion tabs 610 and 612. Accordingly, when a golf club shaft 800 is pressed against the expansion tabs 610 and 612, the golf club shaft 800 presses the expansion tabs 610 and 612 outward to elastically enlarge the opening 608 so that the golf club shaft 800 may be received in the opening 608. Upon the golf club shaft 800 being inserted in the opening 608, the elastic restoring force of the arms 600 and 602 move or snap the arms 600 and 602 back toward the pre-expanded position to frictionally engage the golf club shaft 800 in the opening 608. The arms 600 and 602 may collectively define a partial oval cross-sectional shape, circular cross-sectional shape, rectangular cross-sectional shape, or any other shape that may be similar to correspondingly shaped shaft. The methods, apparatus, and articles of manufacture described herein are not limited in this regard.

The portable electronic device holder 400 may be mounted on a shaft of sports equipment or any cylindrical object. The portable electronic device holder 400 may be mounted on the golf club shaft 800. The portable electronic device holder 400 may engage the golf club shaft 800 at any location on the golf club shaft 800. A portable electronic device may be mounted on the golf club shaft 800 with the portable electronic device holder 400 to capture still and/or video images of an area around the portable electronic device; measure and/or determine relative and/or absolute linear motion, velocity and/or acceleration of the portable electronic device; measure and/or determine relative and/or absolute angular motion, velocity and/or acceleration of the portable electronic device; and/or measure and/or determine relative and/or absolute position of the portable electronic device. Any of the above-described motion, velocity, acceleration and/or position measurements and/or determinations associated with the portable electronic device 1000 may be interpreted as motion, velocity, acceleration and/or position measurements and/or determinations associated with the golf club shaft 800.

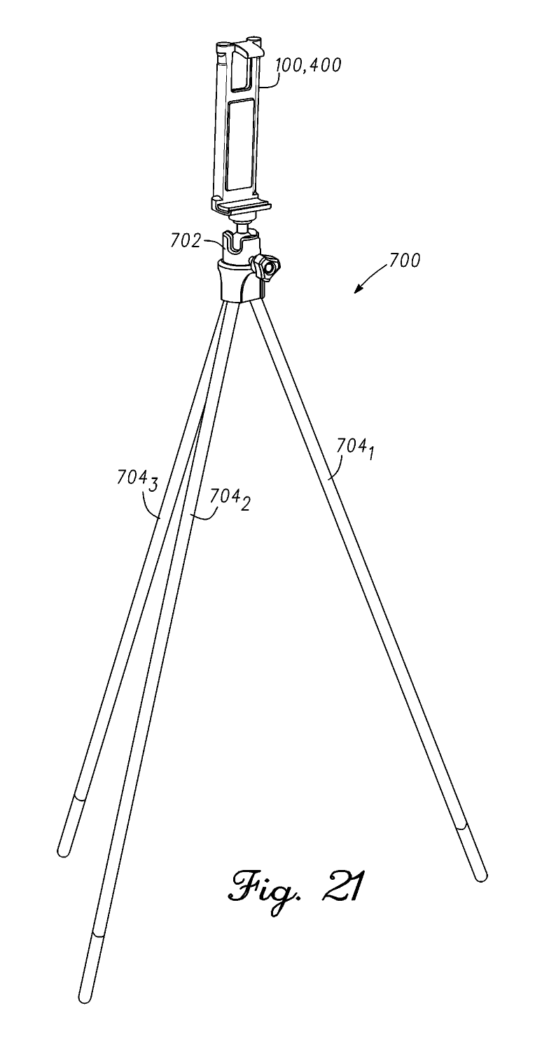

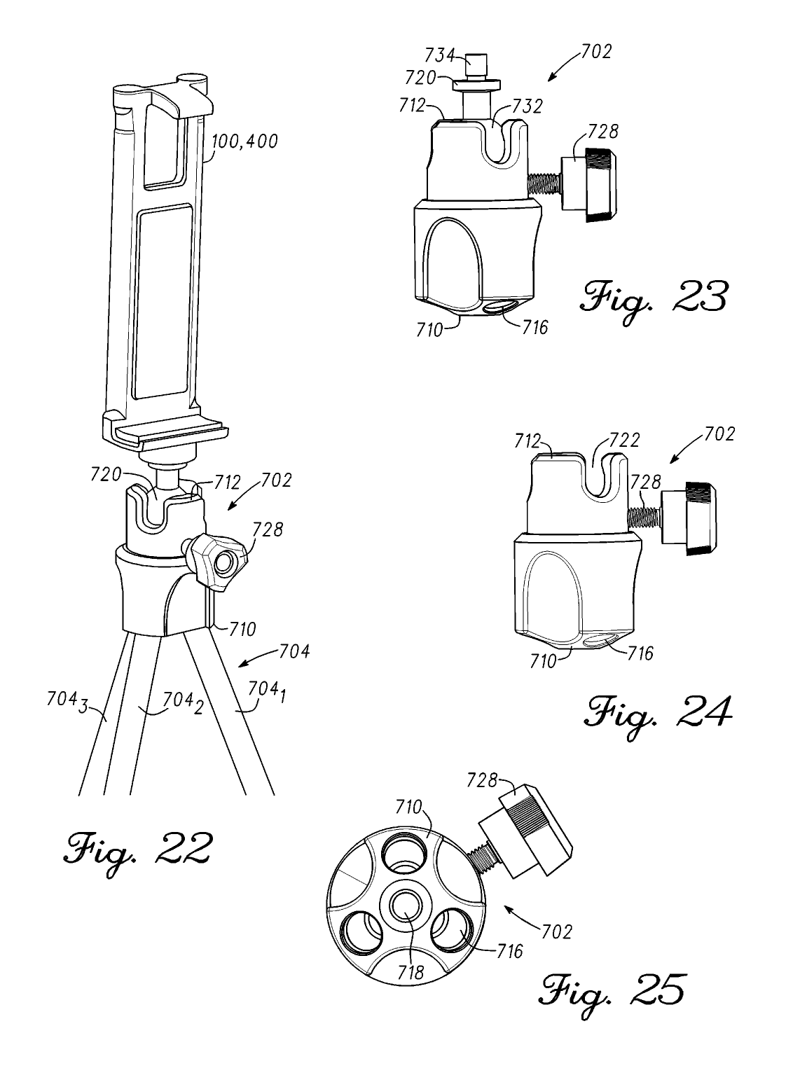

Referring to FIGS. 21-25, the portable electronic device holder 100, 400 may be configured to be removably attached to a stand system 700. In the illustrated embodiment, the stand system 700 includes a coupling member 702 and at least one leg 704. The coupling member 702 includes a first end 710 configured to removably receive the at least one leg 704 and/or a camera stand (not shown), and a second end 712 configured to removably receive the portable electronic device holder 100, 400.

Further referring to FIGS. 21-25, the first end of the coupling member 702 includes at least one cavity 716 configured to receive the at least one leg 704. The cavity 716 may have any shape corresponding to the cross sectional shape of the at least one leg 704. The at least one cavity 716 may include a substantially ring shaped securing member (not shown). The securing member may be made of a rubber-type material capable of frictionally engaging the at least one leg 704 to provide a secure press fit of the at least one leg 704 within the at least one cavity 716. The at least one leg 704 may be an alignment tool used for aligning a golfer's swing. The first end 710 of the coupling member 702 may further include a threaded inner surface 718 capable of receiving a camera stand having mating threads.

Further referring to FIGS. 21-25, the second end 712 of the coupling member 702 includes a ball member 720 positioned within a socket 722, and a threaded fastener 728 capable of provisionally fixing the ball member 720 within the socket 722 in a desired position. The ball member 720 includes a first portion 732 having a substantially spherical shape and a second portion 734 having threads capable of removably coupling the coupling member to a threaded inner surface 750 (shown in FIG. 13) of the portable electronic device holder. The position of the ball member 720 within with socket 722 may be changed by loosening the threaded fastener 728, rotating the ball member 720 to a different position, and tightening the threaded fastener 728.

In the illustrated embodiment, the stand system includes a first leg 704₁, a second leg 704₂, and a third leg 704₃. The first, the second, and the third legs 704₁, 704₂, 704₃ are illustrated in FIG. 18 as alignment tools used to align a golfer's swing. The at least one leg 704 may also be other alignment tools, or any elongated shape capable of forming a stand system 700 with the coupling member 702. In the illustrated embodiment, the at least one leg 704 has an elongated shape with a substantially circular cross section matching a substantially circular cross section of the at least one cavity 716. In other embodiments, the at least one leg 704 may be any elongated shape having any cross sectional shape capable of removably coupling to the at least one cavity 716 in the first end 710 of the coupling member 702.

A golfer may attach the portable electronic device to the golf club shaft 800 or to the coupling member 702 using alignment tools as legs 704 to create a stand system 700. This flexibility provides the golfer with a variety of abilities such as, for example, tracking the position, velocity, acceleration of the golf club during a swing, recording a video of the swing of the golf club or impact of the golf club with a golf ball, or overall recording of the mechanics and tempos of a golfer's swing.

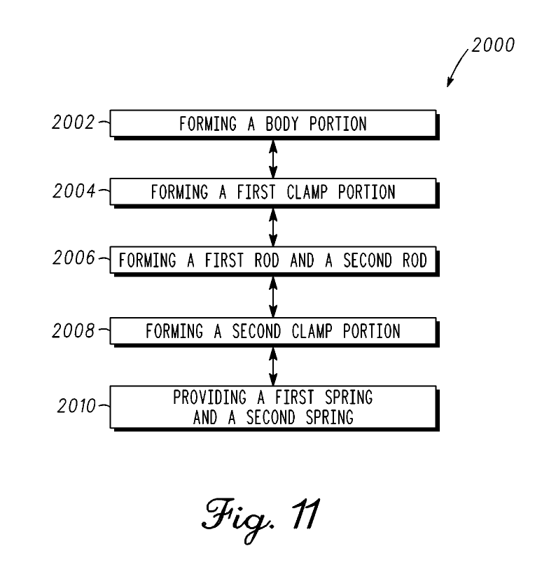

Referring to FIG. 11, a method 2000 of manufacturing an exemplary portable electronic device holder is shown. The method 2000 may include forming a body portion (block 2002), forming a first clamp portion (block 2004), forming a first rod and a second rod (block 2006), forming a second clamp portion (block 2008), and providing a first spring and a second spring (block 2010). The second clamp portion may be formed with the body portion as a single unit. The springs may be formed by any of the processes described herein. Additionally, the first rod and the second rod may be formed together with the first clamp portion.

Any single part or multiple parts of the portable electronic device holder may be constructed from any type of material, such as stainless steel, aluminum, titanium, various metals or metal alloys, composite materials (e.g., Kevlar®, graphite and/or fiberglass), natural materials such as wood or stone or artificial materials such as plastic. Any single part or multiple parts of the portable electronic device holder, such as the body portion, the first and second rods, the first clamp portion and/or the springs may be constructed by stamping (i.e., punching using a machine press or a stamping press, blanking, embossing, bending, flanging, coining, or casting), injection molding, forging, machining or a combination thereof, or other processes used for manufacturing metal, composite, plastic or wood parts. The first and second springs may be coil springs, leaf springs, radial springs, elastomer springs (e.g., annular or cylindrical elastomeric parts) or be constructed with any material and/or have any shape to provide the functions described herein. For example, the body portion including the second clamp portion, the first and second rods and the first clamp portion may be constructed from plastic by an injection molding process. The springs for example may be steel or plastic coil springs. The body portion including the second clamp portion, the first and second rods, the springs and the first clamp portion may then be assembled to form the portable electronic device holder. The body portion or any other part of the portable electronic device holder may be constructed in multiple sections that may be joined together during assembly of the portable electronic device holder. For example, the body portion may be constructed as two halves that are joined together during assembly of the portable electronic device holder.

The above examples are described in connection with a golf club such as a putter-type golf club, a driver-type golf club, a fairway wood-type golf club, a hybrid-type golf club, an iron-type golf club, or a wedge-type golf club. However, the apparatus and articles of manufacture described herein may be applicable other types of sports equipment such as a hockey stick, a tennis racket, a fishing pole, a ski pole, etc.

Although a particular order of actions is described above, these actions may be performed in other temporal sequences. For example, two or more actions described above may be performed sequentially, concurrently, or simultaneously. Alternatively, two or more actions may be performed in reversed order. Further, one or more actions described above may not be performed at all. The apparatus, methods, and articles of manufacture described herein are not limited in this regard.

Although certain example methods, apparatus, systems, and articles of manufacture have been described herein, the scope of coverage of this disclosure is not limited thereto. On the contrary, this disclosure covers all methods, apparatus, systems, and articles of manufacture fairly falling within the scope of the appended claims either literally or under the doctrine of equivalents.

1. A stand system comprising:
at least one leg;
a portable electronic device holder, including;
a body portion comprising a first end portion, a second end portion opposite to the first end portion, a front surface extending between the first end portion and the second end portion, and a back surface extending between the first end portion and the second end portion;
a first clamp portion comprising a first clamp arm extending transverse to the body, the first clamp arm having a curved surface;
a second clamp portion, the second clamp portion comprising a second clamp arm extending transverse to the body, the first clamp portion being moveable relative to the first end portion of the body portion to change a distance between the first clamp portion and the second clamp portion, and the curved surface of the first clamp arm extending toward the second clamp portion, wherein the curved surface exerts a force on a portable electronic device positioned between the first clamp arm and the second clamp arm in a direction toward the body portion to secure the electronic device between the first clamp portion and the second clamp portion; and
a spring configured to connect the first clamp portion to the body portion and bias the first clamp portion toward the first end portion of the body portion such that the first clamp portion and the second clamp portion are configured to engage a portable electronic device and hold the portable electronic device between the first clamp portion and the second clamp portion; and
a coupling member including a first end configured to removably receive the at least one leg or a camera stand, and a second end configured to removably receive the portable electronic device holder.

2. The stand system of claim 1, wherein the portable electronic device holder includes
a first arm positioned on the back surface of the body portion , extending from the back surface in a direction from the front surface to the back surface; and
a second arm positioned on the back surface, extending from the back surface in a direction from the front surface to the back surface, the first arm and the second arm defining an opening wherein when a portion of a golf club shaft is received in the opening, the first arm and the second engage the portion of the golf club shaft to hold the golf club shaft between the first arm and the second arm.

3. The stand system of claim 1, wherein the second end portion of the portable electronic device holder includes a threaded inner surface.

4. The stand system of claim 1, wherein the first end of the coupling member includes at least one cavity capable of removably receiving the at least one leg;

5. The stand system of claim 2, wherein the at least one cavity includes a substantially ring shaped securing member made of a rubber-type material, capable of frictionally securing the at least one leg within the at least one cavity;

6. The stand system of claim 1, wherein the at least one leg is an alignment tool used for aligning a golfer's swing.

7. The stand system of claim 1, wherein the first end of the coupling member includes a threaded inner surface capable of removably coupling with a camera stand.

8. The stand system of claim 1, wherein the second end of the coupling member includes a ball member, a socket, and a threaded fastener capable of provisionally fixing the position of the ball member within the socket.

9. The stand system of claims 3 and 8, wherein the ball member includes a first portion having a spherical shape and a second portion having threads capable of removably coupling the coupling member to the threaded inner surface of the portable electronic device holder.

10. The portable electronic device holder as defined in claim 1, wherein each arm is elastic relative to the body portion.

11. The portable electronic device holder as defined in claim 1, wherein the first clamp portion is moveable relative to the second clamp portion from a first position wherein the first clamp portion is spaced apart from the second clamp portion and the spring is compressed, to a second position wherein the first clamp portion is farther spaced apart from the second clamp portion and the spring is further compressed than in the first position.

12. The portable electronic device holder as defined in claim 1, wherein the first clamp portion comprises a clamp arm extending transverse to the body portion, wherein the second clamp portion comprises a clamp arm extending transverse to the body portion, and wherein the first clamp arm and the second clamp arm are configured to engage opposing portions of a portable electronic device to hold the portable electronic device by the biasing force of the spring.

13. A stand system comprising:
at least one leg;
a portable electronic device holder including:
a body portion comprising:
a first end portion;
a second end portion opposite to the first end portion;
a front surface extending between the first end portion and the second end portion;
a first passage extending between the first end portion and the second end portion;
a second passage extending between the first end portion and the second end portion, and
a first clamp portion comprising a first clamp arm extending transverse to the body portion, the first clamp arm having a curved surface, and a first rod configured to at least partially traverse through the first passage and a second rod configured to at least partially traverse through the second passage;
a second clamp portion comprising a second clamp arm extending transverse to the body portion, the curved surface of the first clamp arm extending toward the second clamp portion, wherein the curved surface exerts a force on the portable electronic device positioned between the first clamp arm and the second clamp arm in a direction toward the body portion to secure the electronic device between the first clamp portion and the second clamp portion;
a first spring disposed in the first passage and configured to operatively couple the first rod to the body portion;
a second spring disposed in the second passage and configured to operatively couple the second rod to the body portion; and
wherein the first spring and the second spring are configured to bias the first clamp portion toward the first end portion of the body portion such that the first clamp portion and the second clamp portion are configured to engage a portable electronic device and hold the portable electronic device between the first clamp portion and the second clamp portion.
a coupling member including a first end configured to removably receive the at least one leg or a camera stand, and a second end configured to removably receive the portable electronic device holder.

14. A stand system comprising:
at least one leg;
a portable electronic device holder including:
a body portion comprising a first end portion, a second end portion opposite to the first end portion, a front surface extending between the first end portion and the second end portion, and a back surface extending between the first end portion and the second end portion;
a first clamp portion comprising a first clamp arm extending transverse to the body, the first clamp arm having a curved surface, and a second clamp portion comprising a second clamp arm extending transverse to the body, the first clamp portion being moveable relative to the first end portion of the body portion to change a distance between the first clamp portion and the second clamp portion, wherein the curved surface exerts a force on a portable electronic device positioned between the first clamp arm and the second clamp arm in a direction toward the body portion to secure the electronic device between the first clamp portion and the second clamp portion;
a spring configured to connect the first clamp portion to the body portion and bias the first clamp portion toward the first end portion of the body portion such that the first clamp portion and the second clam portion are configured to engage a portable electronic device and hold the portable electronic device between the first clamp portion and the second clamp portion;
a first arm fixedly attached to a back surface of the body portion and extending from the body portion and a second arm separate from the first arm and fixedly attached to the back surface of the body portion and extending from the body portion, the first arm and the second arm defining an opening, wherein when a portion of a golf club shaft is received in the opening, the first arm and the second arm engage the portion of the golf club shaft to hold the golf club shaft between the first arm and the second arm;
a coupling member including a first end configured to removably receive the at least one leg or a camera stand, and a second end configured to removably receive the portable electronic device holder.
